(19) United States
(12) Patent Application Publication
(10) Pub. No.: US 2021/0382706 A1
(43) Pub. Date: Dec. 9, 2021

(54) AUTOMATED CONFIGURATION OF ATTESTATION NODES USING A SOFTWARE DEPOT

(71) Applicant: VMware, Inc., Palo Alto, CA (US)

(72) Inventors: Jesse POOL, Ottawa (CA); Samyuktha SUBRAMANIAN, Palo Alto, CA (US); Utkarsh VIPUL, Boston, MA (US)

(21) Appl. No.: 16/892,183

(22) Filed: Jun. 3, 2020

(51) Int. Cl. G06F 8/61; G06F 8/658; G06F 21/57; G06F 16/16; G06F 16/17

(52) U.S. Cl. CPC G06F 8/63; G06F 8/658; G06F 2221/034; G06F 16/164; G06F 16/1734; G06F 21/57

(57) ABSTRACT

A method for an attestation machine to attest a software executing on a remote machine is provided. The method receives, at the attestation machine, a request from the remote machine for attestation of the software executing on the remote machine. The method then determines, by the attestation machine, whether metadata associated with the software is stored at a remote server. The remote server includes several software packages for at least one of installation or upgrade and metadata associated with each of the several software packages. When the metadata associated with the software is stored at the remote server, the method sends, from the attestation machine, an attestation confirmation message to the remote machine.

### BACKGROUND

Remote attestation is the ability for a remote entity (e.g., an attester) to make reliable statements about the software on a target entity. In a network, one or more nodes (e.g., computing devices, host machines, virtual machines, virtual computing instances, etc.), each acting as an attester and referred to as an attestation machine, may be assigned for attestation of software running on other nodes in the network. For example, one or more attestation machines in a datacenter may execute an attestation service for recognizing and validating software (e.g., an operation system) running on other nodes of the datacenter. Conventionally, an administrator may need to manually configure an attestation machine with information needed to perform attestation of software.

In some cases, large datacenters may include tens of thousands of nodes, and the software on such nodes may be changed, upgraded, etc., at different times. As new or updated software is introduced into a datacenter, conventionally, an administrator may have had to take manual steps to reconfigure attestation machines with the information needed to attest the new or updated software, which may be slow and time-consuming.

### BRIEF DESCRIPTION OF THE DRAWINGS

FIG. 1 depicts a block diagram of a computer system in which one or more embodiments of the present disclosure may be utilized.

FIG. 2 is a diagram illustrating an attestation process performed between two nodes of a datacenter without use of a software depot.

FIG. 3 is a diagram illustrating a software installation and/or update process in a datacenter, according to an example embodiment of the present application.

FIG. 4 is a diagram illustrating a direct link between an attestation machine and a software depot for automatically receiving attestation verification data, according to an example embodiment of the present application.

FIG. 5 is a flowchart illustrating example process/method for attesting software running on nodes using a software depot, according to an example embodiment of the present application.

FIG. 6 is a flowchart illustrating an example process/method for determining whether attestation metadata associated with a software is stored at a software depot, according to an example embodiment of the present application.

### DETAILED DESCRIPTION

In order for an attestation machine to be able to validate software (e.g., firmware, an operating system, etc.), it may compare metadata of the software, or an image of the software, as received from a node to metadata or images of previously approved or validated software. For example, in order to recognize and validate operating system software (e.g., ESXi provided by VMware) running on a remote host, the attestation machine may need to be configured with information, such as metadata or an image, that uniquely identifies the operating system software (e.g., type, version, etc.) that is expected to run in the datacenter. To do so, administrators have to continuously curate and update the information configured in the attestation machine.

In some cases, to update the information in an attestation machine, after a new or updated software installation on a node, where the software is known to be valid, metadata associated with the software (e.g., one or more hashes that uniquely identify the software) may be pulled (e.g., by a first user) from the node and then pushed (e.g., by a second user) to the attestation machine (also referred to as an attester). Such pulling and pushing of information may be time consuming.

Accordingly, some embodiments provide an efficient attestation mechanism for nodes in a network (such as datacenters). In some embodiments, one or more attestation machines (e.g., in an attestation cluster) that are responsible for attestation of software running on one or more nodes may leverage a software depot for receiving information (e.g., signed metadata, etc.) associated with the software. For example, in some embodiments, an attestation machine may be linked (e.g., via a network) to a software depot that keeps verified versions of different software (e.g., different software packages) installable on the nodes, such as in different software bundles. For each software, information, such as metadata signed by a software distributer of the software, may also be stored alongside the software (e.g., in the software bundle) at the software depot. By having a link to the software depot, the attestation machine(s) may be able to receive the information associated with all software stored at the software depot automatically. In some embodiments, each time new software is added to the software depot, the associated information may be pushed to the attestation machine(s). In some other embodiments, the attestation machine(s) may periodically check the software depot to receive any new information added to the software depot. In yet some other embodiments, the attestation machine(s) may search the software depot for the information associated with a software when an attestation of the software is needed.

By receiving information associated with a software automatically from the software depot, the need for pulling/pushing of metadata (e.g., by one or more users or administrators) between a remote host machine and an attestation machine may be eliminated (e.g., each time a software is installed/updated on the remote host machine).

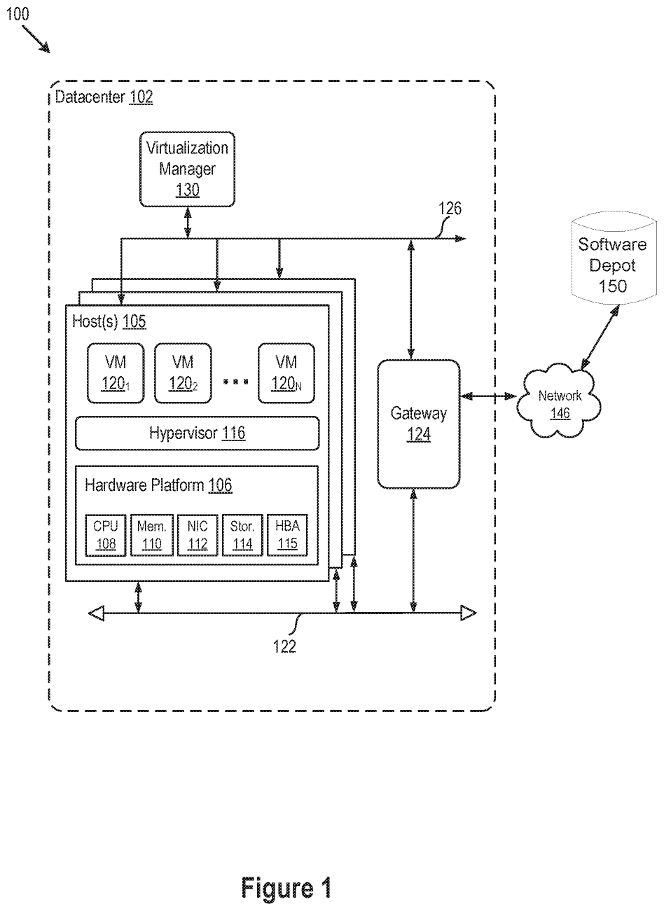

FIG. 1 depicts a block diagram of a computer system 100 in which one or more embodiments of the present disclosure may be utilized. Computer system 100 may include a datacenter 102 connected to a network 146. Network 146 may be, for example, a direct link, a local area network (LAN), a wide area network (WAN), such as the Internet, another type of network, or a combination of these networks.

Datacenter 102 may include host(s) 105, a virtualization manager 130, a gateway 124, a management network 126, and a data network 122. Datacenter 102 may include additional components (e.g., a disturbed data storage, etc.) that are not shown in the figure. Networks 122, 126, in one embodiment, may each provide Layer 2 or Layer 3 connectivity in accordance with the Open Systems Interconnection (OSI) model, with internal physical or software defined switches and routers not being shown. Although the management and data network are shown as separate physical networks, it is also possible in some implementations to logically isolate the management network from the data network (e.g., by using different VLAN identifiers).

Each of hosts 105 may be constructed on a server grade hardware platform 106, such as an x86 architecture platform. For example, hosts 105 may be geographically co-located servers on the same rack.

Hardware platform 106 of each host 105 may include components of a computing device, such as one or more central processing units (CPUs) 108, system memory 110, a network interface 112, storage system 114, a host bus adapter (HBA) 115, and other I/O devices, such as, for example, USB interfaces (not shown). Network interface 112 may enable host 105 to communicate with other devices via a communication medium, such as data network 122 or management network 126. Network interface 112 may include one or more network adapters, which may also be referred to as network interface cards (NICs). In certain embodiments, data network 122 and management network 126 may be different physical networks as shown, and the hosts 105 may be connected to each of the data network 122 and management network 126 via separate NICs or separate ports on the same NIC. In certain embodiments, data network 122 and management network 126 may correspond to the same physical or software defined network, but different network segments, such as different VLAN segments.

Storage system 114 represents persistent storage devices (e.g., one or more hard disks, flash memory modules, solid state disks, non-volatile memory express (NVMe) drive, and/or optical disks). Storage 114 may be internal to host 105, or may be external to host 105 and shared by a plurality of hosts 105, coupled via HBA 115 or NIC 112, such as over a network. Storage 114 may be a storage area network (SAN) connected to host 105 by way of a distinct storage network (not shown) or via data network 122, e.g., when using iSCSI or FCoE storage protocols. Storage 114 may also be a network-attached storage (NAS) or another network data storage system, which may be accessible via NIC 112.

Host 105 may be configured to provide a virtualization layer, also referred to as a hypervisor 116, that abstracts processor, memory, storage, and networking resources of hardware platform 106 into multiple virtual machines 1201 to 120N (collectively referred to as VMs 120 and individually referred to as VM 120) that run concurrently on the same host. Hypervisor 116 may run on top of the operating system in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines.

In some implementations, the hypervisor may comprise system level software as well as a “Domain 0” or “Root Partition” virtual machine (not shown) which is a privileged virtual machine that has access to the physical hardware resources of the host and interfaces directly with physical I/O devices using device drivers that reside in the privileged virtual machine. Although the disclosure is described with reference to VMs, the teachings herein also apply to other types of virtual computing instances (VCIs), such as containers, Docker containers, data compute nodes, isolated user space instances, namespace containers, and the like. In certain embodiments, instead of VMs 120, the techniques may be performed using containers that run on host 105 without the use of a hypervisor and without the use of a separate guest operating system running on each container.

Virtualization manager 130 may communicate with hosts 105 via a network, shown as a management network 126, and carries out administrative tasks for datacenter 102, such as managing hosts 105, managing VMs 120 running within each host 105, provisioning VMs, migrating VMs from one host to another host, and load balancing between hosts 105. Virtualization manager 130 may be a computer program that resides and executes in a central server in datacenter 102 or, alternatively, virtualization manager 130 may run as a virtual computing instance (e.g., a VM) in one of the hosts 105. Although shown as a single unit, virtualization manager 130 may be implemented as a distributed or clustered system. That is, virtualization manager 130 may include multiple servers or virtual computing instances that implement management plane functions.

Although hosts 105 are shown as including a hypervisor 116 and virtual machines 120, in an embodiment, hosts 105 may include a standard operating system instead of a hypervisor 116, and hosts 105 may not include VMs 120. In such an embodiment, datacenter 102 may not include virtualization manager 130.

Gateway 124 may provide hosts 105, VMs 120, and other components in datacenter 102 with connectivity to one or more networks used to communicate with one or more remote datacenters or other entities, such as software depot 150. Gateway 124 may manage external public Internet Protocol (IP) addresses for VMs 120 and route traffic incoming to and outgoing from datacenter 102 and provide networking services, such as firewalls, network address translation (NAT), dynamic host configuration protocol (DHCP), and load balancing. Gateway 124 may use data network 122 to transmit data network packets to hosts 105. Gateway 124 may be a virtual appliance, a physical device, or a software module running within host 105.

Although shown as a remote entity, software depot 150 may be a part (e.g., one of the components) of datacenter 102. In some embodiments, as described in more detail below, hosts 105 may use software depot 150 to receive new/updated software (e.g., new installations, patches, updates, etc.) that are stored at software depot 150. For example, when a host 105 is required to upgrade its operating system (e.g., ESXi provided by VMware), the host may receive an updated version of the operating system stored at the software depot 150. For example, the host itself or another managing VM or device (e.g., an update manager) may connect to software depot 150 (e.g., through gateway 124 and network 146) and receive the updated version of the operating system. Where another managing VM or device receives the updated version of the operating system, it may orchestrate the upgrade of the operating system for the host 105, such as by sending the updated version of the operating system to the host 105. In some embodiments, as will be described in more detail below, a software update manager server (e.g., that is a component of datacenter 102, or a remote server) may manage the software installations and upgrades on different hosts 105.

In some embodiments, each software bundle stored at software depot 150 may include information, such as signed metadata (e.g., in XML file format) that describes, among other things, the name and corresponding hash of each file in the software bundle. The metadata may be signed by the software distributor of the software bundle (e.g., by VMware). In some embodiments, one or more host machines 105 (e.g., attestation machines dedicated for performing attestation services) of datacenter 102 may connect to software depot 150 to receive the signed metadata for verifying (or attesting) the binaries (e.g., of the operating system software) running on the other host machines of datacenter 102.

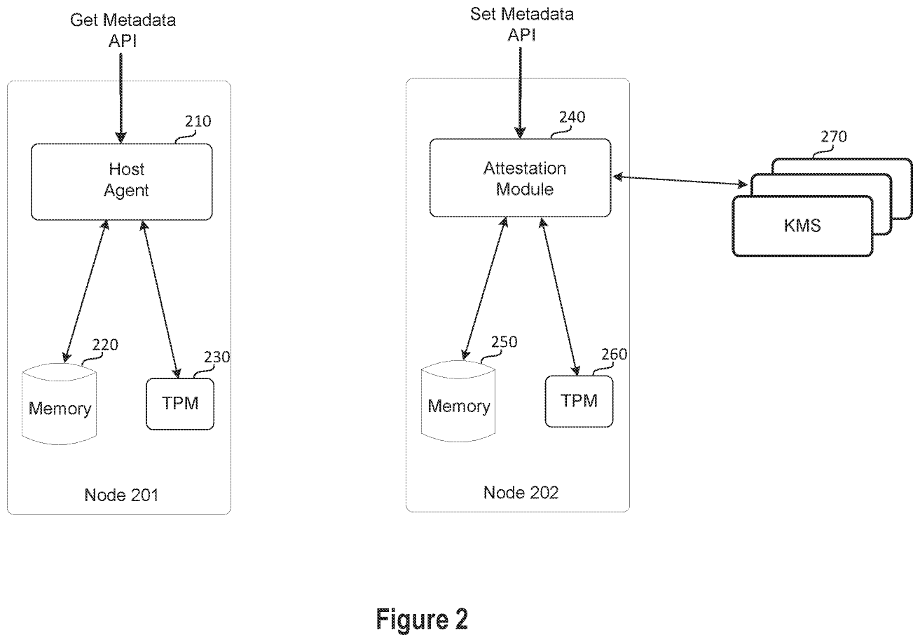

FIG. 2 is a diagram illustrating an attestation process performed between two nodes of a datacenter without use of a software depot. FIG. 2 includes a first node (e.g., host machine) 201, a second node (e.g., host machine) 202, and one or more key management servers 270. Each node may include, among other components, as described in FIG. 1, a memory, such as memories 220 and 250 (e.g., a non-volatile storage 114, with reference to FIG. 1) and a Trusted Platform Module (TPM), such as TPMs 230 and 260. The first node 201 may also include a host agent (or module) 210 for managing attestation requests. The second node 202 may include an attestation module 240 for attesting different software of other nodes, such as node 201. Each of these modules (or agents) may reside in the hypervisor 116 or may be independent of the hypervisor 116. Each of TPMs 230 and 260 may be a tamper resistant piece of cryptographic hardware or processor (e.g., in hardware platform 106) in nodes 201 and 202, which may implement cryptographic functions (e.g., computing hash functions, key management and generation, random number generation, integrity measurements, etc.) for software attestation.

A trusted software bundle (e.g., ESXi package) stored at memory 220 of node 201 may include trusted metadata associated with the software. For later attestation of the software stored at memory 220 (e.g., when the software executes on node 201 or another node), this metadata should be first configured to the attestation machine (or host) 202 to be able to attest the software. As such, an administrator (e.g., a workload admin) may need to pull the trusted metadata from host 201. In some embodiments, the admin may use an application programing interface (API) to receive the metadata associated with the software. The admin may then send the metadata to another admin (e.g., a management admin) to push (or configure) the metadata to node 202. In some embodiments, the management admin may also use an API to push the metadata to the attestation machine. The metadata may be stored at a local memory of node 202, such as memory 250.

Later, during an attestation process of the software on node 201 or another node (e.g., when the software is executed for the first time), host agent 210 may send the metadata generated from execution of the software (e.g., and measured by TPM 230) to node 202. After attestation module 240 compares the received metadata with the metadata previously configured to node 202 (e.g., and stored at memory 250), the attestation module may be able to attest the software (e.g., when the two metadata match) or deny verification of the software (e.g., when the node 202 does not store matching metadata). For example, when a software is executed on node 201, agent 210 may send an event log of the software execution to the attestation module 240 of host 202. Attestation module 240 may use the received event log to attest the software running on node 201.

For example, the event log may include one or more entries that each may contain a hash of a component of the software generated (e.g., and measured into TPM 230) during the execution of the software. In some embodiments, attestation module 240 may replay the events of the event log in the same order to recreate the hashes (e.g., using TPM 260) to determine the authenticity of the software. In some embodiments, one or more hashes in the event log may be compared (e.g., by attestation module 240) to signed hashes in metadata stored at memory 250 to attest the software. After a successful authentication of the software, attestation module 240 may generate an attestation certificate (or token), for example, using TPM 260 of the attestation machine, and send the attestation token to host agent 210 of node 201. In some embodiments, attestation module 240 may generate the attestation certificate without using TPM 260. In some cases, node 201 may then use the attestation token to receive encryption keys from, for example, one of the key management servers in KMS 270, such as to be used for further communication with other services.

As described above, in some embodiments an update manager (e.g., vSphere update manager (VUM) provided by VMware) may be used by users of a datacenter to install, upgrade, and/or patch software (e.g., operating system software, third-party software, firmware, etc.) on the nodes. The update manager may be connected to a software depot (e.g., vSphere installation bundle (VIB) depot provided by VMware) which may store different software installation bundles, such as provided by different software vendors/distributers. A software installation bundle, in some embodiments, may, similar to a tarball or ZIP archive, contain a group of files packaged into a single archive (e.g., to facilitate data transfer and distribution).

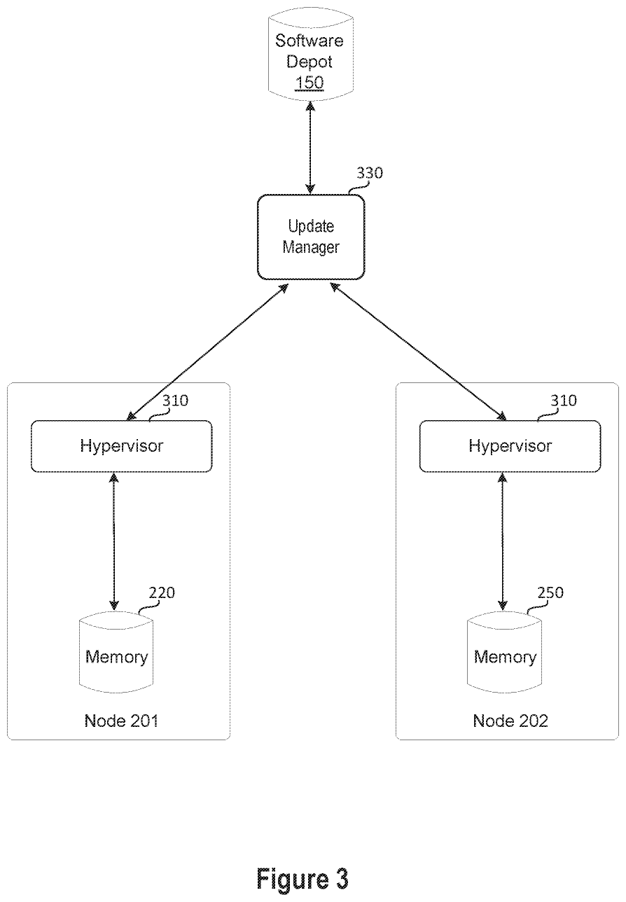

FIG. 3 is a diagram illustrating a software installation and/or update process in a datacenter, according to an example embodiment of the present application. More specifically, this figure illustrates two nodes 201 and 202 that may connect to update manager 340 (e.g., through data network 122 and/or network 146, with reference to FIG. 1) to receive software bundles from software depot 150. Update manager 340 may be a service executed on one of nodes 105, or on a remote server outside datacenter 102.

Node 201, as described above with reference to FIG. 2, may be a node that does not include an attestation service for attesting software running on other nodes, while node 202 may be an attestation machine that includes such a service (e.g., attestation module 240). As shown in FIG. 2, both nodes 201 and 202 may connect to the update manager 330 through their hypervisors 310. For example, a software update management service residing in each hypervisor 310 may be responsible for software installation and update on the nodes. In some other embodiments, another module that is independent of the hypervisor may connect each node to update manager 330. Update manager 330, as described above, may be another node in the datacenter that is dedicated for update management, a virtual machine (VM) running on another node, a remote server outside the datacenter, etc.

Software depot 150 (e.g., VIB depot) may be a repository of software bundles (e.g., VIBs) that are available online to update manager 330 (e.g., VUM) users. In some embodiments, a software depot, such as depot 150, may be created and maintained to control the software bundles that are accessed by different users. Software depot 150 may include the same or similar metadata (e.g., in the software bundles) that is consumed by an attestation machine (e.g., by the attestation module 240) when establishing software trust. Depots are generally either offline bundles that contain the software files and relevant metadata, or online depots which are essentially extracted offline bundles hosted on the web locations.

Update manager 330 may determine that new software needs to be installed/upgraded on any of the nodes 201 or 202. Update manager 330 may accordingly forward a request for the new software/update to software depot 150. If the requested version of the software is stored at software depot 150, update manager 330 may transmit the updated version to the node with instruction to install. Hypervisor 310 of the node may in turn install the updated version on the node and store the required files of the software at memory 220 (when node 201 is required to upgrade) or 250 (when node 202 is required to upgrade).

As described above, in some embodiments, one or more attestation machines (e.g., in an attestation cluster) that are responsible for attestation of software running on the nodes of the datacenter may use software depot 150 for receiving the signed metadata associated with the different software. For example, the attestation module 240 of an attestation machine may be configured to link directly to software depot 150 (e.g., by adding a uniform resource locator (URL) address that points to the depot's online location to the module). By having a direct link to the software depot, the attestation machine(s) may be able to receive the signed metadata associated with every software bundle stored at the software depot automatically.

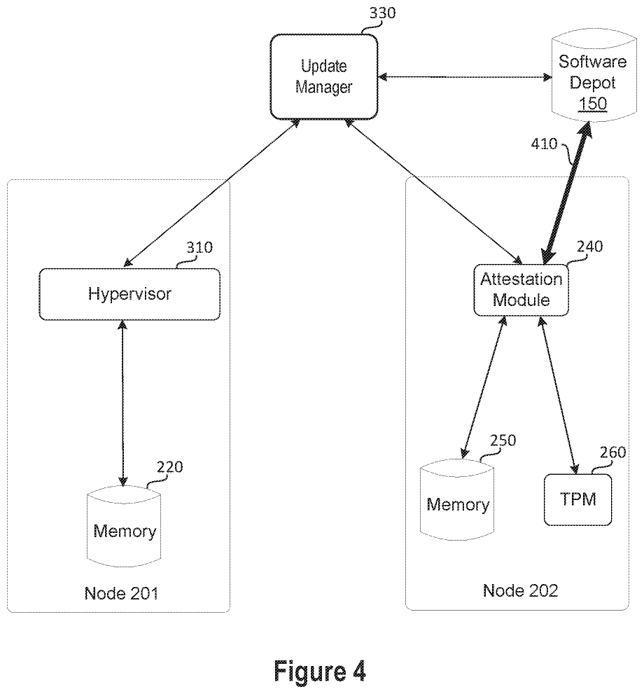

FIG. 4 is a diagram illustrating a direct link between an attestation machine and a software depot for automatically receiving attestation verification data, according to an example embodiment of the present application. As shown in the figure, the components of FIG. 4 are very similar to FIG. 3 with the exception of the addition of a direct link 410 that is established between software depot 150 and attestation module 240. Configuring attestation module 240 to be linked to software depot 150 may enable the attestation machine (e.g., node 202) to automatically receive the signed metadata (e.g., VIB metadata) associated with each software bundle that is stored at software depot 150 directly from the depot.

By receiving the signed metadata associated with a software automatically from the software depot, the need for pulling/pushing of metadata (e.g., by one or more users or administrators) between a remote node and an attestation machine may be eliminated (e.g., each time a software is installed/updated on the remote node). Additionally, pointing directly to the software depot for automatically receiving the signed metadata of the software may eliminate the need for the two-step manual process of attestation of the software. Instead, the signed metadata may be configured to the attestation machines (e.g., in the attestation cluster) by automatically downloading metadata of the software to the attestation cluster when they become available on the software depot.

The signed metadata may be received dynamically from software depot 150 differently in different embodiments. For example, in some embodiments, each time a new software bundle is added to software depot 150, the associated metadata may be pushed to attestation machine 202 (e.g., as well as to other attestation machines of the attestation cluster). In some other embodiments, attestation machine 202 may periodically check software depot 150 to receive any new metadata added to the software depot. In yet some other embodiments, attestation machine 202 may search software depot 150 for the signed metadata associated with a software each time an attestation of the software is needed.

It should be noted that even though software depot 150 in FIG. 4 and the other figures is described to contain software bundles, the software depot described above and below may also include firmware bundles. That is, the methods and techniques described above and below for attesting software may equally apply to the attestation of firmware. For example, when a firmware of node 201 is required to be attested, attestation machine 202 may receive the metadata associated with the firmware from node 201. The attestation machine may then compare the received metadata with metadata stored (e.g., in a firmware bundle associated with the firmware for which attestation is required) at a software/firmware depot, such as software depot 150. If the metadata match, the attestation machine may attest the firmware.

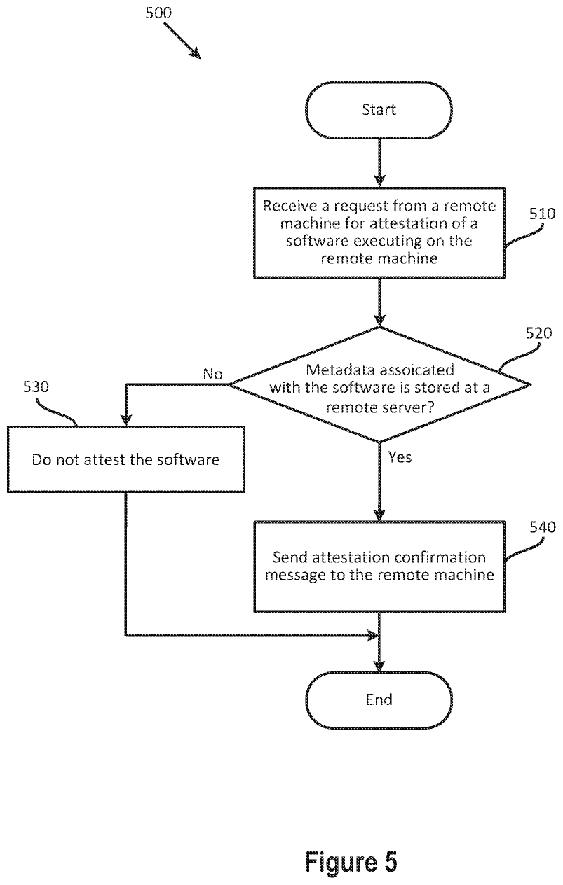

FIG. 5 is a flowchart illustrating example process/method 500 for attesting software running on nodes using a software depot, according to an example embodiment of the present application. Process 500 may be performed, for example, by an attestation module (e.g., such as attestation module 240, as shown in FIG. 2) executing on an attestation machine. Process 500 may begin, at 510, by receiving, at the attestation machine, a request from a remote node for attestation of a software executing on the remote node. As described above, the request may have an event log associated with the software sent by a host agent of a node that runs the software. The event log may include, among other data (e.g., software identification (ID), event type, etc.), one or more hashes that are generated and measured (e.g., by a TPM) during the execution of the software.

At 520, process 500 may continue by determining whether metadata associated with the software is stored at a remote server (e.g., software depot 150) which may include (i) several software packages for at least one of installation or upgrade and (ii) metadata associated with each of the software packages. For making such a determination, different embodiments use different approaches.

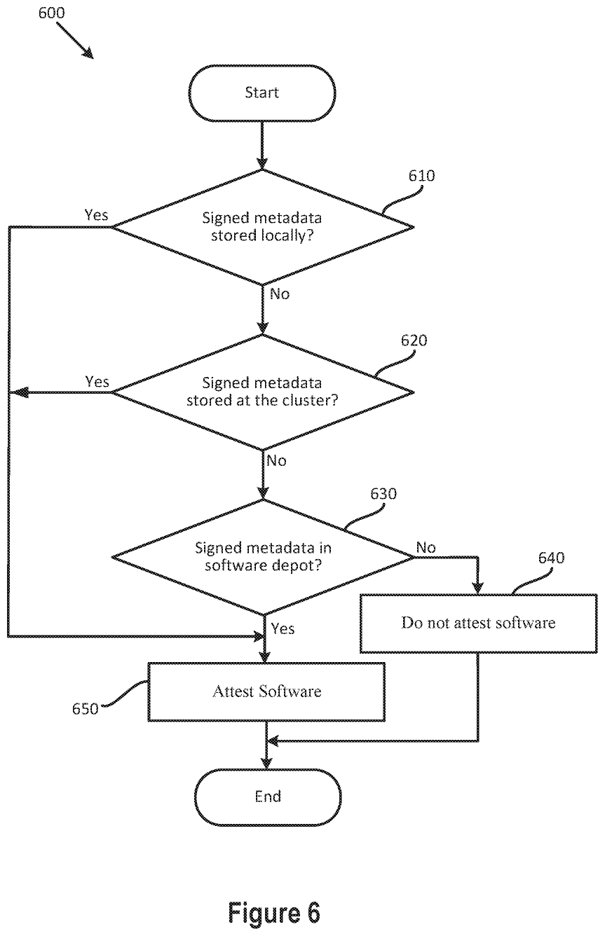

FIG. 6 is a flowchart illustrating an example process/method 600 for determining whether attestation metadata associated with a software is stored at a software depot, according to an example embodiment of the present application. Process 600 may start, at 610, by determining whether the signed metadata is stored locally at the attestation machine. As described above, in some embodiments, the attestation machines may periodically search the software depot and download metadata associated with any newly added software bundle from the software depot. Additionally, in some embodiments, the software depot may push metadata associated with any new software bundle after the software bundle is added to the software depot. In some such embodiments, the attestation machine may store the received metadata in its local memory for later attestation of the software. If process 600 determines that the signed metadata is stored locally at the attestation machine, the process may proceed to operation 650, which is described below.

When process 600 determines that the signed metadata is not stored locally at the attestation machine, the process may determine, at 620, whether the metadata is stored at any other attestation machine in the attestation cluster. For example, another attestation machine may have been recently updated by newly added metadata to the software depot before the current attestation machine have received the metadata. As such, at any point time, there might be new metadata that is not stored locally but is stored at another attestation machine of the cluster. If process 600 determines that the signed metadata is stored at another attestation machine in the attestation cluster, the process may proceed to operation 650, which is described below.

When process 600 determines that the signed metadata is not stored locally at the attestation machine, nor is it stored at any other attestation machine in the cluster, the process may determine, at 630, whether the metadata is stored at the software depot. That is, in some embodiments, the attestation machine may look for the signed metadata in the software depot only when the metadata cannot be found at the machine or the cluster. If process 600 determines that the signed metadata is not stored at the software depot, the process may not, at 640, attest the software and may end. On the other hand, if process 600 determines that the signed metadata is stored at the software depot, the process may confirm, at 650, the attestation of the software. The process may then end. It should be noted that any combination of 610-630 may be performed in some embodiments, such as performing only 610 and 630, performing only 630, etc.

It should be noted that when the signed (or trusted) metadata is no more needed, it can be simply removed from the software depot. That is, the untrusted metadata may be removed from the software depot when they are no longer in use by the datacenter (or the customers of the datacenter. For example, in some embodiments, each time a software bundle is removed from software depot 150, the software depot may transmit a message to the attestation cluster to remove the associated metadata from their local memories (e.g., in those embodiments where the attestation machines periodically search the software depot and store the new metadata locally, or where the software depot pushes any newly added metadata to the attestation cluster machines).

Returning to FIG. 5, when process 500 determines (at 520) that the metadata associated with the software is not stored at the remote server (e.g., at the software depot), process 500 may send, at 530, an error message to the requesting machine to inform the requesting machine that the software cannot be authenticated. The process then ends. On the other hand, if process 500 determines that the signed metadata is stored at the remote server, the process may send, at 540, an attestation confirmation message to the requesting machine. The process may then end.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

1. A method for an attestation machine to attest a software executing on a remote machine, the method comprising:
receiving, at the attestation machine from a remote server, metadata associated with each of a plurality of software packages for at least one of installation or upgrade, the receiving based on the remote server automatically sending the metadata to the attestation machine when a new software package is added to the remote server;
receiving, at the attestation machine, a request from the remote machine for attestation of the software executing on the remote machine, wherein the remote machine, before sending the request to the attestation machine, connects to an update management server that is responsible for at least one of installing, upgrading, or updating the software on the remote machine;
determining, by the attestation machine, whether metadata associated with the software is received from the remote server; and
when the metadata associated with the software is received from the remote server, sending, from the attestation machine, an attestation confirmation message to the remote machine.

2. The method of claim 1, wherein the request from the remote machine comprises at least an event log associated with the software, wherein the event log comprises at least identification data for the software and other metadata.

3. The method of claim 2, wherein determining whether the metadata associated with the software is received from the remote server comprises:
comparing the other metadata received in the request with the metadata received from the remote server.

4. The method of claim 1, wherein the metadata associated with each of the plurality of software packages comprises a name and a corresponding hash for each file belonging to the associated software package, and is signed by a software distributor of each software package.

5-6. (canceled)

7. The method of claim 1, wherein the software comprises one of an operating system software, firmware, or an application executing on the remote machine.

8. A non-transitory computer readable medium comprising instructions that, when executed by one or more processors of a computing system, cause the computing system to perform a method for an attestation machine to attest a software executing on a remote machine, the method comprising:
receiving, at the attestation machine from a remote server, metadata associated with each of a plurality of software packages for at least one of installation or upgrade, the receiving based on the remote server automatically sending the metadata to the attestation machine when a new software package is added to the remote server;
receiving, at the attestation machine, a request from the remote machine for attestation of the software executing on the remote machine, wherein the remote machine, before sending the request to the attestation machine, connects to an update management server that is responsible for at least one of installing, upgrading, or updating the software on the remote machine;
determining, by the attestation machine, whether metadata associated with the software is received from the remote server; and
when the metadata associated with the software is received from the remote server, sending, from the attestation machine, an attestation confirmation message to the remote machine.

9. The non-transitory computer readable medium of claim 8, wherein the request from the remote machine comprises at least an event log associated with the software, wherein the event log comprises at least identification data for the software and other metadata.

10. The non-transitory computer readable medium of claim 9, wherein determining whether the metadata associated with the software is received from the remote server comprises:
comparing the other metadata received in the request with the metadata received from the remote server.

11. The non-transitory computer readable medium of claim 8, wherein the metadata associated with each of the plurality of software packages comprises a name and a corresponding hash for each file belonging to the associated software package, and is signed by a software distributor of each software package.

12-13. (canceled)

14. The non-transitory computer readable medium of claim 8, wherein the software comprises one of an operating system software, firmware, or an application executing on the remote machine.

15. A computer system, comprising:
a memory; and
a processor coupled to the memory, the processor being configured to:
receive, at the attestation machine from a remote server, metadata associated with each of a plurality of software packages for at least one of installation or upgrade, the receiving based on the remote server automatically sending the metadata to the attestation machine when a new software package is added to the remote server;
receive, at the attestation machine, a request from the remote machine for attestation of the software executing on the remote machine, wherein the remote machine, before sending the request to the attestation machine, connects to an update management server that is responsible for at least one of installing, upgrading, or updating the software on the remote machine;
determine, by the attestation machine, whether metadata associated with the software is received from the remote server; and
when the metadata associated with the software is received from the remote server, send, from the attestation machine, an attestation confirmation message to the remote machine.

16. The computer system of claim 15, wherein the request from the remote machine comprises at least an event log associated with the software, wherein the event log comprises at least identification data for the software and other metadata.

17. The computer system of claim 16, wherein determining whether the metadata associated with the software is received from the remote server comprises:
comparing the other metadata received in the request with the metadata received from the remote server.

18. The computer system of claim 15, wherein the metadata associated with each of the plurality of software packages comprises a name and a corresponding hash for each file belonging to the associated software package, and is signed by a software distributor of each software package.

19-20. (canceled)

21. The method of claim 1, wherein the remote server stores each new software package added to the remote server.

22. The non-transitory computer readable medium of claim 8, wherein the remote server stores each new software package added to the remote server.

23. The computer system of claim 15, wherein the remote server stores each new software package added to the remote server.
